(19) United States
(12) Patent Application Publication
(10) Pub. No.: US 2026/0147636 A1
(43) Pub. Date: May 28, 2026

(54) APPARATUS AND METHOD FOR RESOURCE USAGE OPTIMIZATION BASED ON MULTI-LAYER DISTRIBUTED EXECUTION

(71) Applicant: Electronics and Telecommunications Research Institute, Daejeon (KR)

(72) Inventors: Su-Min JANG, Sejong-si (KR); Dae-Won KIM, Daejeon (KR)

(73) Assignee: Electronics and Telecommunications Research Institute, Daejeon (KR)

(21) Appl. No.: 19/392,650

(22) Filed: Nov. 18, 2025

(30) Foreign Application Priority Data
Nov. 28, 2024 (KR) 10-2024-0173210
Sep. 24, 2025 (KR) 10-2025-0138309

(51) Int. Cl. G06F 9/50

(52) U.S. Cl. CPC G06F 9/5077; G06F 9/5038; G06F 9/505

(57) ABSTRACT

Disclosed herein is an apparatus and method for resource usage optimization based on multi-layer distributed execution. The apparatus parses and analyzes container resource allocation information and a Quality-of-Service (QoS) profile for multiple layers from predetermined deployment configuration data, executes an identical container image for each layer for which resource availability is confirmed based on the resource allocation information, determines whether QoS is satisfied by measuring a response period and computing performance for each executed layer based on the QoS profile, selects an optimal layer that satisfies the resource availability and the QoS, and optimizes resource usage by gradually reducing resource usage setting parameters of the optimal layer, checking whether the QoS is satisfied at each reduction stage, and searching for a minimum resource value.

### CROSS REFERENCE TO RELATED APPLICATIONS

This application claims the benefit of Korean Patent Applications No. 10-2024-0173210, filed Nov. 28, 2024, and No. 10-2025-0138309, filed Sep. 24, 2025, which are hereby incorporated by reference in their entireties into this application.

### BACKGROUND OF THE INVENTION

### 1. Technical Field

The present disclosure relates generally to artificial intelligence (AI) and resource optimization technology, and more particularly to technology for resource usage optimization based on multi-layer distributed execution.

### 2. Description of the Related Art

In recent years, advancement in robotics and AI technology has opened up the possibility for robots to assist humans in performing various tasks in daily life. In particular, global companies such as Google, Microsoft, Amazon, and Tesla are developing these technologies by combining their cloud platforms with robotics and AI. However, despite such progress, there are still several key issues and challenges that need to be addressed.

The main challenge is the limitation of autonomy and the ability to handle complex tasks. Current robotic systems demonstrate high performance in predefined procedures and environments but struggle to adapt to unexpected situations or changes. Also, it is difficult for robots to effectively handle various complex tasks in real life, especially AI (composite task) services, with only computing resources of devices embedded in the robots, so they provide only limited services due to computing resource constraints. In particular, the ability to perform tasks in atypical and unpredictable environments is still limited, and it is often impossible to handle tasks.

The robots proposed in Google's Everyday Robots project may perform various autonomous tasks and perform highly complex tasks, such as selecting a specific object and then picking up and moving the object, sorting and throwing away different types of waste, and the like. In particular, the project includes learning and training for robots to become a human-assistive tools in unstructured and unpredictable daily life environments of people. In the Everyday Robots project, learning is performed by following human demonstrations, sharing experiences with other robots, and conducting simulations in a cloud environment. If the Everyday Robots project is successfully achieved, it may enable development of general-purpose assistive robots that can accompany humans in everyday environments such as homes and offices.

Another major challenge concerns the limitations of data processing and learning. In order for a robot to autonomously operate, it must be able to process and learn massive amounts of data in real time. However, current cloud-based AI (composite task) systems face difficulties in efficient learning and operation due to data transmission latency, bandwidth limitations, and insufficient real-time processing capability. This problem is particularly critical for tasks where real-time responses are important. To solve this problem, distributed processing of AI (composite task) operations for autonomous robots using the robot itself, edge computing, and cloud computing is very effective.

As such, the need for autonomous robots continues to grow. They not only enhance productivity by performing repetitive and simple tasks on behalf of humans but also play an important role in protecting human life in hazardous environments. Not only in logistics, manufacturing, and disaster relief but also in everyday households, they perform various tasks, such as cleaning, cooking, and caregiving, thereby greatly improving convenience in daily life. In the long term, they have significant cost-saving effects, and the ability to accurately collect and process data is becoming an essential technology even in fields such as agriculture and healthcare.

The development direction of future autonomous robots focuses on securing a high level of autonomy based on more advanced AI and enabling natural interaction with humans. Collaborative robots will perform multiple tasks simultaneously to maximize efficiency, and discussions on ethical issues and legal regulations associated with the introduction of robots will also be active. These technologies are expected to spread to all industries and bring innovation to human life and industry.

Meanwhile, U.S. Patent Application Publication US2022/0291666, titled “AI solution selection for an automated robotic process”, discloses a method for selecting an AI solution for an automated robotic process.

### SUMMARY OF THE INVENTION

An object of the present disclosure is to optimize resource usage in an autonomous robot, thereby reducing wasted resources resulting from resource settings arbitrarily configured by a user.

Another object of the present disclosure is to provide efficient usage of computing resources of an autonomous robot, improvement in real-time performance and response speed, efficiency in data processing and storage, improvement in energy efficiency, and scalability and flexibility.

In order to accomplish the above objects, an apparatus for resource usage optimization based on multi-layer distributed execution according to an embodiment of the present disclosure includes one or more processors and memory for storing at least one program executed by the one or more processors, and the at least one program parses and analyzes container resource allocation information and a Quality-of-Service (QoS) profile for multiple layers from predetermined deployment configuration data, executes an identical container image for each layer for which resource availability is confirmed based on the resource allocation information, determines whether QoS is satisfied by measuring a response period and computing performance for each layer based on the QoS profile, selects an optimal layer satisfying the resource availability and the QoS, and optimizes resource usage by gradually reducing resource usage setting parameters of the optimal layer, checking whether the QoS is satisfied at each reduction stage, and searching for a minimum resource value.

Here, the multiple layers may be distinguished as work nodes in which at least one of a computing resource size, or a network processing speed, or a combination thereof differs.

Here, the at least one program may optimize the resource usage by dynamically adjusting the size or number of GPU instances according to a service load.

Here, the at least one program may optimize the resource usage by adjusting the size and number of instances based on GPU virtualization that partitions a single GPU into multiple independent instances.

Here, the at least one program may optimize the resource usage by performing a predetermined inference service on a first instance and performing a predetermined training task on a second instance that is larger than the first instance.

Here, the QoS profile may include at least one of a deadline, reliability, durability, a latency budget, or a history item, or a combination thereof.

Here, the at least one program may generate and output optimal deployment configuration data that reflects the optimal layer and the minimum resource value.

Here, the at least one program may modify the resource usage setting parameters using the optimal deployment configuration data and search for the minimum resource value.

Here, the at least one program may generate an inference model by training a predetermined suitable fixed learning model selected from among multiple fixed learning models by adjusting service environment information acquired from predetermined service input according to characteristics of a service.

Here, the at least one program may adjust at least one of input resolution of the service, a backbone structure, the number of classes, anchor settings, or floating-point precision, or a combination thereof in the service environment information.

Here, the at least one program may update the container resource allocation information and the QoS profile based on result data that the inference model produces for the predetermined service input.

Also, in order to accomplish the above objects, a method for resource usage optimization based on multi-layer distributed execution, performed by an apparatus for resource usage optimization based on multi-layer distributed execution, according to an embodiment of the present disclosure includes parsing and analyzing container resource allocation information and a Quality-of-Service (QoS) profile for multiple layers from predetermined deployment configuration data, executing an identical container image for each layer for which resource availability is confirmed based on the resource allocation information, determining whether QoS is satisfied by measuring a response period and computing performance for each layer based on the QoS profile, selecting an optimal layer satisfying the resource availability and the QoS, and optimizing resource usage by gradually reducing resource usage setting parameters of the optimal layer, checking whether the QoS is satisfied at each reduction stage, and searching for a minimum resource value.

Here, the multiple layers may be distinguished as work nodes in which at least one of a computing resource size, or a network processing speed, or a combination thereof differs.

Here, optimizing the resource usage may comprise optimizing the resource usage by dynamically adjusting the size or number of GPU instances according to a service load.

Here, optimizing the resource usage may comprise optimizing the resource usage by adjusting the size and number of instances based on GPU virtualization that partitions a single GPU into multiple independent instances.

Here, optimizing the resource usage may comprise optimizing the resource usage by performing a predetermined inference service on a first instance and performing a predetermined training task on a second instance that is larger than the first instance.

Here, the QoS profile may include at least one of a deadline, reliability, durability, a latency budget, or a history item, or a combination thereof.

Here, optimizing the resource usage may comprise generating and outputting optimal deployment configuration data that reflects the optimal layer and the minimum resource value.

Here, optimizing the resource usage may comprise modifying the resource usage setting parameters using the optimal deployment configuration data and searching for the minimum resource value.

Here, analyzing the container resource allocation information and the QoS profile may comprise generating an inference model by training a predetermined suitable fixed learning model selected from among multiple fixed learning models by adjusting service environment information acquired from predetermined service input according to characteristics of a service.

Here, analyzing the container resource allocation information and the QoS profile may comprise adjusting at least one of input resolution of the service, a backbone structure, the number of classes, anchor settings, or floating-point precision, or a combination thereof in the service environment information.

Here, analyzing the container resource allocation information and the QoS profile may comprise updating the container resource allocation information and the QoS profile based on result data that the inference model produces for the predetermined service input.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a concept of distributed AI (composite task) execution using three layers according to an embodiment of the present disclosure;

FIG. 2 is a flowchart illustrating a method for resource usage optimization based on multi-layer distributed execution according to an embodiment of the present disclosure;

FIG. 3 is a view illustrating an example of resource allocation information and Quality-of-Service (QoS) information settings for an autonomous robot according to an embodiment of the present disclosure;

FIG. 4 is a view illustrating a process of selecting an optimal layer through simultaneous execution of three layers according to an embodiment of the present disclosure;

FIG. 5 is a view illustrating a process for minimizing resource usage through a resource usage controller in a selected layer according to an embodiment of the present disclosure;

FIG. 6 is a view illustrating a process of partitioning a GPU into various sizes and allocating the same according to an embodiment of the present disclosure;

FIG. 7 is a view illustrating a process of differentially applying network models of various sizes according to an embodiment of the present disclosure;

FIG. 8 is a view illustrating a process of generating an AI inference model by adjusting service environment information based on service input according to an embodiment of the present disclosure; and

FIG. 9 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are provided to fully describe the present disclosure to a person having ordinary knowledge in the art. Accordingly, the shapes, sizes, etc. of components in the drawings may be exaggerated in order to make the description clearer.

Throughout the specification, when a part “includes” a component, which means that it may further include other components, rather than excluding other components, unless otherwise specified.

Because the present disclosure may be variously changed and may have various embodiments, specific embodiments will be described in detail below with reference to the attached drawings.

However, it should be understood that those embodiments are not intended to limit the present disclosure to specific disclosure forms and that they include all changes, equivalents or modifications included in the spirit and scope of the present disclosure.

Various terms, such as “first”, “second”, “A”, “B”, “(a)”, “(b)”, etc., can be used to describe components of embodiments of the present disclosure. These terms merely differentiate one component from the other, but the substances, order, or sequence of the components are not limited by the terms.

Unless defined differently, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

In the present disclosure, it will be understood that when a component is referred to as being “connected” or “coupled” to another component, it can be directly connected or coupled to the other component, or intervening components may be present.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, components, or combinations thereof, but do not preclude the presence or addition of one or more other features, integers, steps, operations, components, or combinations thereof.

Hereinafter, preferred embodiments of the present disclosure will be described in detail with reference to the accompanying drawings. In the following description of the present disclosure, independent reference numerals are used for components that may be the same in the drawings, in order to facilitate an overall understanding.

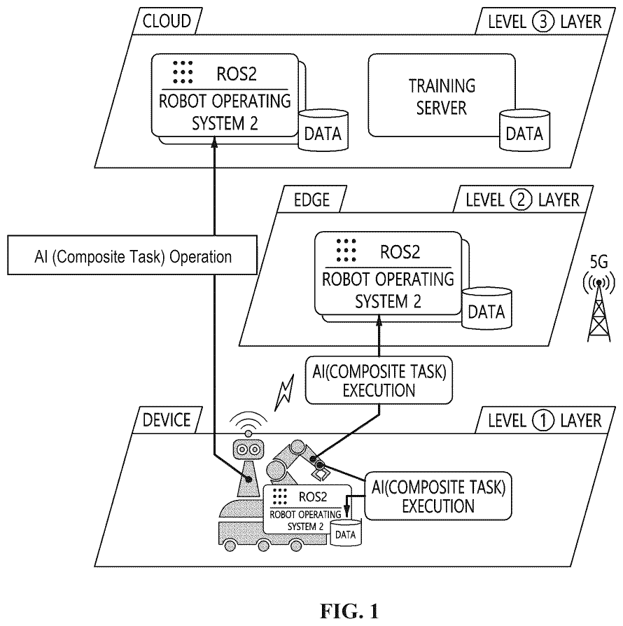

FIG. 1 is a view illustrating a concept of distributed AI (composite task) execution using three layers according to an embodiment of the present disclosure.

Representative AI (composite task) operations required for an autonomous robot are as follows. These operations are very complex and require massive amounts of computing resources.

Object recognition and tracking refer to the capability of a robot to recognize and track various objects in a surrounding environment. For example, in home, the robot may throw away trash after locating a trash bin or may accurately find an object that needs to be moved (e.g., computer vision (CV), image classification, object detection (You Only Look Once (YOLO))).

Natural Language Processing (NLP) refers to the capability of a robot to understand and execute commands through conversations with users. The robot may recognize voice commands, understand the context of conversations, and provide appropriate answers or take actions (e.g., speech recognition, text generation, command understanding, chatbots).

Path planning and autonomous navigation refer to the capability of a robot to autonomously move in a given environment. It requires the ability to navigate to a destination indoors and outdoors while avoiding obstacles or to efficiently find a complex route (e.g., Simultaneous Localization and Mapping (SLAM), GPS navigation, obstacle avoidance).

Situational awareness and decision-making refer to the capability of a robot to understand changes and situations in a surrounding environment and to make appropriate decisions based thereon. For example, when someone collapses, the robot may recognize it as an emergency and request assistance (e.g., reinforcement learning, behavior prediction, emotional recognition).

Collaborative interaction refers to the capability of a robot to perform a task by cooperating with other robots or humans. This may include the ability to divide tasks or solve more complex missions through collaboration (e.g., multi-agent systems, human-robot interaction (HRI)).

The AI (composite task) operations presented above include highly complex operations, which require fast processing speeds and massive amounts of computing resources. In order to effectively handle such complex operations, distributing the AI (composite task) operations using the robot itself, edge computing, and cloud computing is effective in multiple aspects. First, the robot itself performs fundamental data processing and tasks requiring real-time responsiveness, thereby enabling immediate environment recognition and rapid decision-making. Accordingly, operations such as obstacle avoidance or simple path planning are smoothly executed. Edge computing processes more complex operations by utilizing edge servers near the robot, thereby compensating for the hardware limitations of the robot and minimizing delays caused by data transmission. As a result, large-scale data processing may be performed locally, and there are advantages of saving network bandwidth and maintaining real-time performance.

Additionally, the use of cloud computing enables processing of tasks that require extensive data analysis and high-performance computation. For example, training of deep-learning models or complex simulations are performed in the cloud, which has the effect of using unlimited computational resources to perform operations that are difficult for the robot to handle by itself. Such a distributed processing structure allows optimal performance to be achieved at each computing level, thereby reducing latency and ensuring real-time responsiveness. Also, this hierarchical data processing method reduces the amount of data transmission and increases network efficiency by transmitting data to the cloud only when necessary.

In conclusion, distributing AI (composite task) operations for an autonomous robot using the robot itself, edge computing, and cloud computing may provide various advantages, such as efficient use of computing resources, improved real-time performance and response speed, efficient data processing and storage, improved energy efficiency, scalability, flexibility, and the like. Also, when simultaneously handling a large number of autonomous robots, for example, 50˜100 robots rather than a single robot, minimizing the computing resources used by modules that serve to process each robot's tasks becomes a highly important and frequently discussed issue.

Referring to FIG. 1, the reason for distributed execution of AI (composite task) operations across three parts, which are a cloud, an edge, and a robot (device), for autonomous robot development is that it is necessary to optimize performance, improve reliability, and overcome the limitations of resources of the autonomous robot itself. The robot itself has limited computational capability and storage space, which makes it difficult for the robot to perform complex AI (composite task) operations. It can be seen that the parts (nodes) capable of handling robot-related tasks are classified into three layers.

First, the cloud server (level 3 layer) has the largest computing resources but the slowest network processing speed.

The edge server (level 2 layer) has medium-scale computing resources and a medium network processing speed.

The device (robot) (level 1 layer) has the smallest computing resources but the fastest network processing speed.

The cloud server and the edge server play a role in distributed processing of various complex operations required for the robot to operate and provide related services, and particularly, they may support faster processing methods by utilizing acceleration devices specialized for AI-related operations. Accordingly, it is possible to compensate for the computing resource limitations of the device (robot) and guarantee stable and rapid AI (composite task) execution responses through efficient resource utilization, enhanced system resilience, and latency minimization.

Therefore, in the present disclosure, it is very important to determine the layer that is more efficient for distributed execution of the composite task of the robot.

Efficient distributed processing of AI (composite task) operations related to an autonomous robot may be provided to achieve improvements in computing efficiency, real-time performance, and energy efficiency.

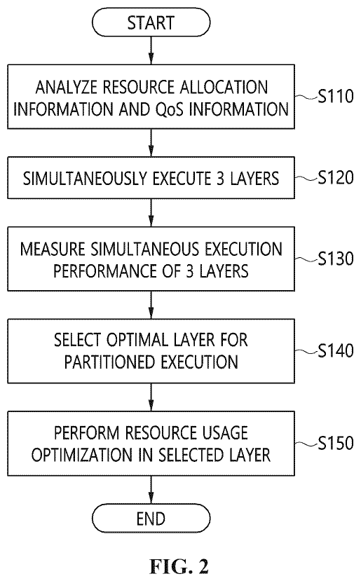

FIG. 2 is a flowchart illustrating a method for resource usage optimization based on multi-layer distributed execution according to an embodiment of the present disclosure.

Referring to FIG. 2, in the method for resource usage optimization based on multi-layer distributed execution according to an embodiment of the present disclosure, first, resource allocation information and Quality-of-Service (QoS) information may be analyzed at step S110.

That is, at step S110, container resource allocation information and a QoS profile for multiple layers may be parsed and analyzed from predetermined deployment configuration data.

Here, at step S110, a Docker or a container may be used to improve development efficiency and stability by maintaining environment consistency, managing dependency, simplifying deployment, facilitating scaling, and rapidly performing tests and deployment in autonomous robot development.

Here, at step S110, the resource allocation information may be identified by analyzing a YAML file in which the details of the Docker or container are set.

The resource allocation information may include information about CPUs, memory, GPUs, user-defined resources, and the like.

Here, at step S110, Robot Operating System 2(ROS2 ), which is a robot software framework that provides functions such as sensor integration, control, communication, data processing, and the like, may be used for autonomous robot operations.

The Quality-of-Service (QoS) profile of ROS 2 serves to optimize the quality of data transmission between robots by setting the levels of communication reliability, latency, and priority.

Here, at step S110, the QoS information may be confirmed through the QoS profile.

The QoS information may include a deadline, reliability, durability, a latency budget, and a history.

The deadline may specify the maximum time allowed for a message to be transmitted and received.

The reliability may specify the reliability of message delivery, and may be set to ‘reliable’ or ‘best effort’.

The durability may specify whether messages are retained even after a system restarts.

The latency budget may specify the maximum latency allowed for a message to be delivered.

The history may specify a buffering method and the number of messages to be stored.

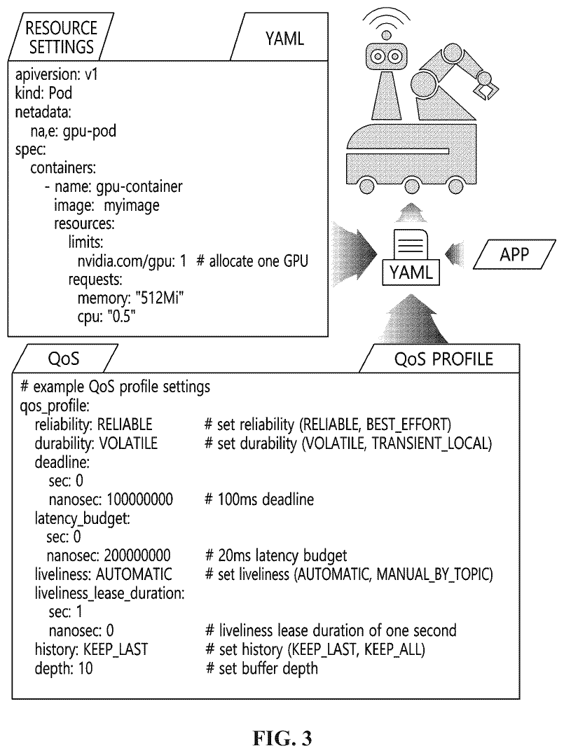

FIG. 3 is a view illustrating examples of resource allocation information and QoS information settings for an autonomous robot according to an embodiment of the present disclosure.

Referring to FIG. 3, it can be seen that a procedure in which a single configuration YAML document into which resource setting YAML and a ROS 2 QoS profile are integrated is distributed and applied to a robot through an application in an autonomous robot system is illustrated.

It can be seen that the resource setting YAML shows an example of resource settings for container orchestration. The resource setting YAML includes Pod-level metadata and container image specifications, and in the resource section, the minimum resources that should be guaranteed for the container and the upper limits of resources available for the container are declaratively described by specifying the GPU limit, memory request, and CPU request.

The QoS profile applied to ROS 2 communication is configured to include items such as a reliability setting, a durability setting, a deadline, a latency budget, liveliness, lease duration, a history, and a depth so that the definitions of message delivery reliability, time constraints, and buffering policies can be seen at a glance. It can be seen that annotations are added to indicate that the deadline represents the maximum allowable interval between samples and the latency budget represents the upper limit of the delay allowed for message delivery.

The YAML document illustrated in the center shows that the resource parameters defined in the resource setting YAML and the communication quality parameters defined in the QoS profile are integrated into a single deployment unit.

Also, in the method for resource usage optimization based on multi-layer distributed execution according to an embodiment of the present disclosure, three layers may be simultaneously executed at step S120.

That is, at step S120, the same container image may be simultaneously executed for each layer for which resource availability is confirmed based on the resource allocation information.

Here, at step S120, the three layers (a cloud server, an edge server, and a device) may be simultaneously executed.

Here, the multiple layers may be distinguished as work nodes in which at least one of a computing resource size, or a network processing speed, or a combination thereof differs.

Here, at step S120, it may be determined whether the required resources specified in the YAML file can be provided in each layer.

Here, at step S120, if the required resources can be provided, the corresponding layer may be executed.

Particularly, at step S120, a program that processes an AI (composite task) execution request may be executed in the form of an identical container in each layer.

Also, in the method for resource usage optimization based on multi-layer distributed execution according to an embodiment of the present disclosure, the simultaneous execution performance of the three layers may be measured at step S130.

That is, at step S130, whether QoS is satisfied may be determined by measuring a response period and computing performance for each executed layer based on the QoS profile.

Here, at step S130, the performance results received after simultaneous execution of the three layers (the cloud server, the edge server, and the device) may be measured.

Here, at step S130, whether the preset performance QoS is satisfied may be checked.

Also, in the method for resource usage optimization based on multi-layer distributed execution according to an embodiment of the present disclosure, an optimal layer for partitioned execution may be selected at step S140.

That is, at step S140, the optimal layer that satisfies the resource availability and the QoS may be selected.

Here, at step S140, at least one layer that satisfies the preset performance QoS may be selected from among the three layers (the cloud server, the edge server, and the device).

Here, at step S140, if none of the layers satisfies the preset performance QoS, the computing performance of each layer may be changed to satisfy the required QoS, or the execution program may be redesigned or developed to satisfy the required QoS.

Here, at step S140, when the QoS is satisfied in at least one layer, it may be recommended to select and execute a higher-level layer. Through this process, the cloud server or edge server serves to perform distributed processing of various composite tasks required for the robot to operate and provide related services, thereby providing various advantages such as efficient use of computing resources, improved real-time performance and response speed, efficient data processing and storage, improved energy efficiency, scalability and flexibility, and the like.

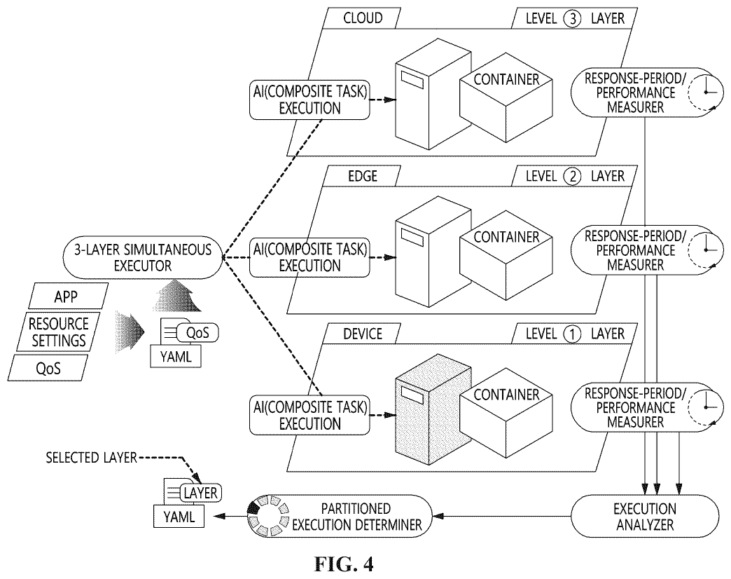

FIG. 4 is a view illustrating a process of selecting an optimal layer through simultaneous execution of three layers according to an embodiment of the present disclosure.

Referring to FIG. 4, it can be seen that a procedure in which container-based AI composite tasks are simultaneously executed in three layers including a cloud, an edge, and a device, the response period and performance of each layer are measured and analyzed, an optimal layer is selected based on the analysis results, and a YAML document corresponding to the optimal layer is output is illustrated.

It can be seen that the YAML document generated from an application, resource settings, and QoS information is input to a three-layer simultaneous executor, as indicated by arrows.

It can be seen that, in the three-layer simultaneous executor, the container components of the three layers, which are the cloud, the edge, and the device, simultaneously execute AI (composite task) operations in parallel.

In each layer, a response-period/performance measurer may measure the response period and performance for the AI (composite task) operations.

An execution analyzer may aggregate and analyze the measurement values of each layer.

It can be seen that a partitioned execution determiner produces a YAML document to be applied for the final deployment of the optimal layer that is selected by evaluating the analysis results of the measurement values.

Also, in the method for resource usage optimization based on multi-layer distributed execution according to an embodiment of the present disclosure, resource usage optimization may be performed in the selected layer at step S150.

That is, at step S150, resource usage optimization may be derived by controlling container resource settings for handling an AI (composite task) service execution request in the selected optimal layer.

Here, at step S150, computing resource settings may be partially modified using a resource usage controller based on execution analysis.

Here, at step S150, measuring the response period and performance in response to the modification is repeatedly performed, and the minimum resource setting that satisfies the user-defined QoS may be derived.

Here, at step S150, a YAML file in which the selected layer and the optimal resource parameter values satisfying the QoS are defined may be output as the final result.

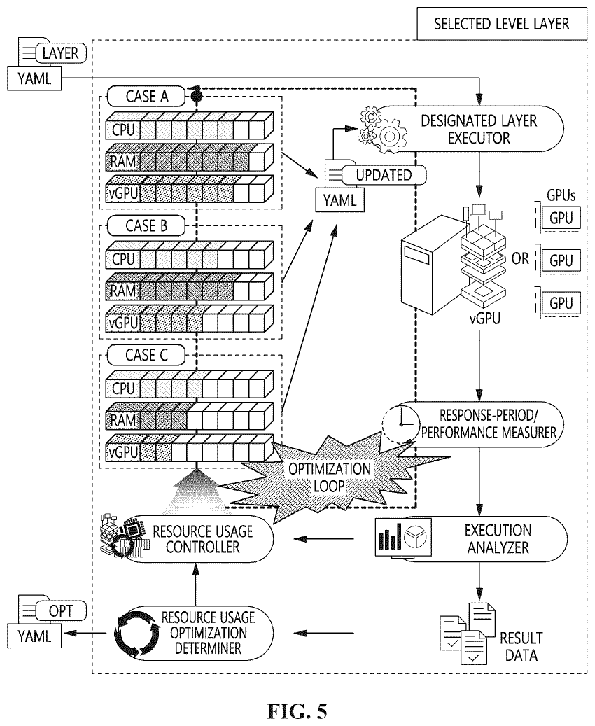

FIG. 5 is a view illustrating a process for minimizing resource usage through a resource usage controller in the selected layer according to an embodiment of the present disclosure.

Referring to FIG. 5, it can be seen that a procedure in which the minimum resource setting satisfying QoS is derived by gradually reducing and adjusting resource usage in the execution environment of the selected layer and then the result is output as a configuration file is illustrated.

It can be seen that, in the selected layer, CASE A, CASE B, and CASE C that assume different resource allocations are represented in the form of horizontal bars and that the allocated amounts of CPU, RAM, and vGPU for each case are visualized in block units. It can be seen that, for each case, an updated YAML configuration file (updated YAML) reflecting the resource values for the case is generated. The updated YAML configuration file is delivered to the designated layer executor again, whereby the actual container is launched.

It can be seen that execution in the corresponding layer is performed on physical multi-GPU setups or GPU virtualization (vGPU), single-GPU, multi-GPU, or vGPU partition.

The execution result is delivered to the response-period/performance measurer to measure performance metrics, such as response time, throughput, and the like, and then, the execution analyzer collects and analyzes the measured data and outputs the analysis results as result data in the form of a report.

The analysis results from the execution analyzer are delivered to the resource usage controller, and the result data is returned to a resource usage optimization determiner to determine whether the current resource settings satisfy the target QoS and whether further reduction is possible. Based on the determination result, the resource usage controller minutely adjusts the allocation ratios of CPU, RAM, and vGPU, and the adjusted values are reflected back to the cases, whereby the same execution, measurement, and analysis procedures are repeatedly performed through the optimization loop. Such repetition may continue until further reducing resources is no longer possible while maintaining the target QoS.

Finally, when the iterative optimization is completed, the minimum resource values satisfying the target QoS are set, and the optimized YAML configuration file, which is expressed as “OPT YAML” at the bottom of the drawing, is generated.

Also, at step S150, optimal GPU resources may be used through a multi-size multi-GPU partitioning method.

Here, at step S150, the size or number of GPU instances is dynamically adjusted depending on the service load, whereby the resource usage may be optimized.

Here, at step S150, the size and number of instances are adjusted based on GPU virtualization, which partitions a single GPU into multiple independent instances, whereby the resource usage may be optimized.

Here, at step S150, resource usage settings for CPU and RAM may be easily reduced step by step by partially modifying the computing resource settings. However, the resource usage optimization for GPU resources is particularly significant because the use of GPU virtualization technology allows efficient distribution of GPU resources and handling of various workloads. The GPU virtualization technology enables a single GPU to be partitioned into multiple independent instances, so it is possible to adjust the resources based on the requirements of each workload, without wasting the resources, even when multiple AI models or services are simultaneously run. As a result, lightweight inference services are run on small instances, but complex training tasks are performed on larger instances, whereby the utilization of the GPU resources may be maximized.

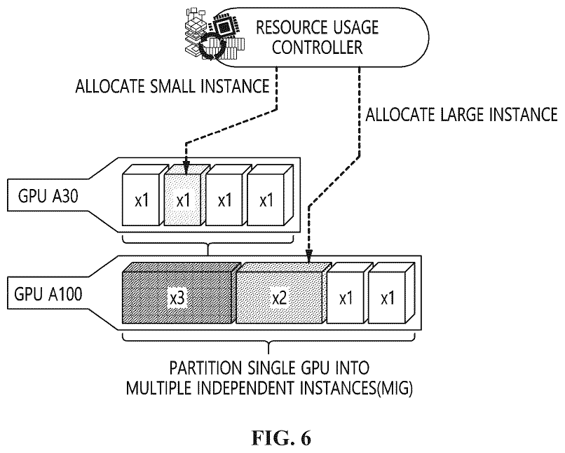

FIG. 6 is a view illustrating a process of partitioning a GPU into various sizes and allocating the same according to an embodiment of the present disclosure.

Referring to FIG. 6, it can be seen that a single GPU is partitioned into various sizes and allocated in order to utilize instances of various sizes.

The resource usage controller allocates small instances to GPU A30 and allocates large instances to GPU A100.

The GPU A30 represents a configuration in which the GPU is evenly partitioned into multiple instances of the same size, and the GPU A100 represents a partitioning configuration in which large instances, medium instances, and small instances are mixed. Each block is labeled with designations such as x1, x2, x3, etc. to indicate the relative size and the allocation ratio of each instance. The resource usage controller determines the size and number of instances based on the target QoS and the current load, and it can be seen that the instances are deployed as available partitions of the corresponding GPU based on the determined configuration. The configuration assumes the technology for partitioning a single GPU into multiple independent instances, for example, Multi-Instance GPU (MIG), and accordingly, lightweight inference and high-load tasks may be performed in parallel in the same device while reducing interference between services, and dynamic scaling is possible in response to changing demand.

Also, GPU virtualization minimizes resource interference between services, thereby preventing performance degradation when AI models are simultaneously run. Each instance operates independently, which may reduce the impact of the load of one service to another service. This ensures stable resource utilization and enables smooth operation without performance degradation even when multiple AI (composite task) services are simultaneously run. Also, the GPU virtualization technology provides flexible scaling, thereby enabling the size of GPU instances to be dynamically adjusted according to the service load. Accordingly, when the inference workload increases, large instances may be allocated, but when the load decreases, small instances may be allocated, whereby resource usage may be optimized.

Here, at step S150, network models of various sizes for AI models, which are used for major AI (composite task) services, may be differentially applied.

Here, at step S150, resource usage may be optimized by running a lightweight inference service on a small instance and performing a complex training task on a larger instance.

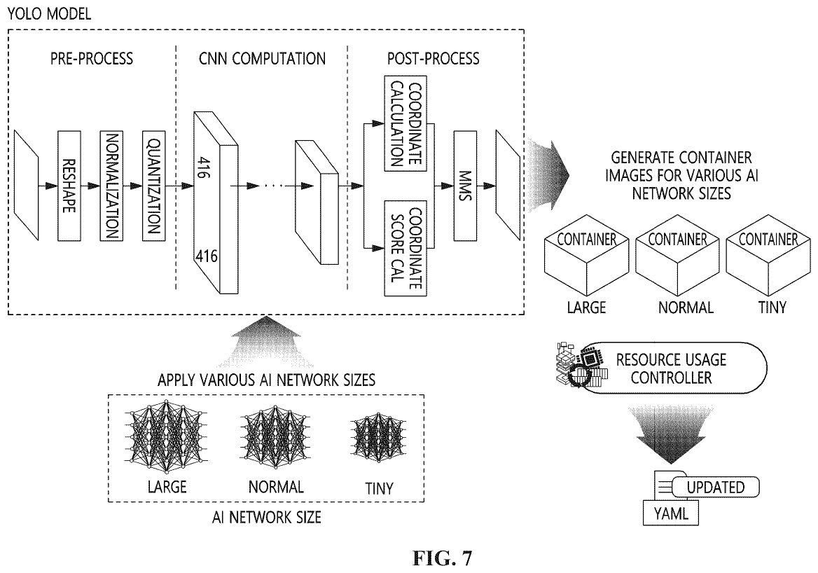

FIG. 7 is a view illustrating a process for differentially applying network models of various sizes according to an embodiment of the present disclosure.

Referring to FIG. 7, the commonly used You Only Look Once (YOLO) model exhibits different processing speeds and performance levels depending on a network size, and this acts as a critical factor in AI-based object detection technology. YOLO has various network sizes ranging from a lightweight model to a high-performance large-scale model, and each model is optimized for a specific application domain. For example, YOLO-tiny is a lightweight network that has a small number of layers and parameters, so it provides fast speed in a real-time inference task. Although it can demonstrate excellent performance in resource-constrained mobile devices or real-time applications, it has lower accuracy than a large model.

In contrast, medium-size models, such as YOLOv3 and YOLOv4, may provide appropriate processing speeds while maintaining high accuracy through more parameters and a complex layer structure. These models are suitable for tasks that require large-scale object detection and enable real-time processing on high-performance hardware. These models are generally selected when a balance between speed and accuracy is required.

Large-scale models, for example, networks such as YOLOv5x, have high object-detection precision but have the limitation of low processing speeds. These models are more suitable for precise image analysis or offline video processing, rather than real-time applications, and they exhibit optimal performance on high-performance GPUs.

Consequently, the network size of the YOLO model greatly affects processing speed and accuracy. As the network size is smaller, the speed increases, and as the network size is larger, accuracy is improved, but the speed is reduced. Therefore, it is essential to select an optimal model for each application domain. A lightweight model is suitable for real-time applications, whereas a large model is suitable for a task requiring high accuracy. Based on these characteristics, the resource usage controller proposed in the present disclosure may optimize resource usage through the differential application of network models of various sizes.

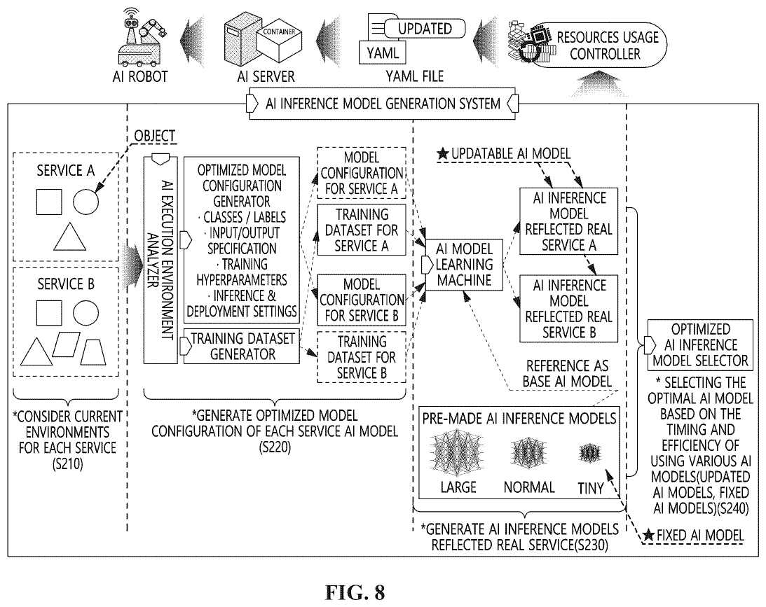

FIG. 8 is a view illustrating a process of generating an AI inference model by adjusting service environment information based on service input according to an embodiment of the present disclosure.

Referring to FIG. 8, it illustrates a process of significantly optimizing computing resource usage by differentially applying YOLOv5 models of different sizes and by using a small number of classes required for an actual service.

The YOLOv5 model, which is an AI model primarily used for object recognition, is generally known to have five basic size variants, which are YOLOv5n (Nano), YOLOv5s (Small), YOLOv5m (Medium), YOLOv5l (Large), and YOLOv5x (Extra Large).

These models adjust the depth and width of the model by varying depth_multiple and width_multiple values of the network to adjust the depth and width of the model, thereby providing a model with an adjusted tradeoff between speed and accuracy. This supports the model to be utilized in various forms for resource-constrained mobile devices or real-time applications in various environments. In each model, the number of parameters and FLOPs indicate the complexity of the network and the computational load, respectively, which increase in the order of n<s<m<l. The YOLOv5-based models provide various architectures ranging from lightweight to large-scale networks. YOLOv5n and YOLOv5s have a small number of parameters and a low computational load, so they are suitable for edge devices but have low accuracy. YOLOv5m seeks a balance between speed and accuracy, and YOLOv5l, YOLOv5x, and YOLOv5n6 provide high accuracy but have low inference speeds. Therefore, it is necessary to differentially apply such models of different sizes to be optimized for each autonomous service robot. In conclusion, the size of an AI model greatly affects the processing speed and accuracy.

Also, in the YOLOv5 model, when only a small number of classes for each specific service, rather than all 80 classes in the COCO dataset, are used, there are several effects in terms of a computational load and learning efficiency. First, the output dimension of a detection head is proportional to the number of classes and the number of anchors, so reducing the number of classes decreases the parameters in a final layer, thereby reducing the computational load and memory usage. Accordingly, it is expected to have the effect of slightly improving the inference speed. Also, reducing the number of classes has a positive impact on learning efficiency. As the number of categories to be classified decreases, the network may focus on distinguishing limited objects, and the proportion of data for each class is relatively increased, which results in improvement in learning stability. Furthermore, the possibility of confusion between classes is reduced, which may result in improvement in the detection performance for a specific class. However, this approach may sacrifice generalizability. A model trained on the entire COCO dataset may be used for recognition of various objects, but a model trained on a reduced class set is specialized for a specific domain and cannot be applied for detection of other objects. Therefore, class reduction is highly effective for a specific domain for application services that are clearly defined, such as traffic sign recognition, specific animal detection, or industrial defect detection.

Also, in the YOLOv5 model, multiple model configuration data elements, such as an input size, the number of classes, anchor settings, and a backbone structure, are flexibly adjusted, which results in various effects in terms of a computational load and learning efficiency. For example, reducing an input image size (imgsz) decreases the computational load and memory usage and improves the inference speed, but detection performance for small objects may be somewhat reduced. Conversely, using larger resolution enhances accuracy but increases the computational cost. Reducing the number of classes decreases the output dimension of the detection head and reduces the number of parameters in the final layer, which enhances inference speed and memory efficiency and improves learning stability. Meanwhile, optimizing the anchor settings for a dataset may significantly improve detection performance for small objects or vertically elongated objects and reduce unnecessary prediction, whereby efficiency may be ensured. Finally, changing the backbone network or selecting a lightweight model makes it possible to balance performance and speed for various computing environments. By adjusting service environment information according to the context and service goals, as described above, it is possible to optimize the balance between inference speed and accuracy and to design models specialized for specific application services (e.g., traffic sign recognition, specific animal detection, industrial defect detection, and the like). However, such adjustment partially sacrifices generalizability, so careful selection is required according to the actual application purpose. Accordingly, the resource usage controller proposed in the present disclosure differentially applies models of various sizes and selectively uses only a small number of classes for each service, thereby optimizing resource usage.

Consequently, the expected effect of the present disclosure is to maximize the utilization of computational resources by flexibly adjusting the service environment information according to the characteristics of an application service and by combining a strategy of selecting an optimal model in consideration of the timing and efficiency of application of various AI models (updatable AI models and fixed AI models).

Specifically, by tuning parameters, such as input resolution, a backbone structure, the number of classes, anchor settings, and a precision level (FP32/FP16/INT8), according to the situation, inference speed and memory efficiency may be guaranteed in edge device environments and high precision may be achieved in large-scale computing environments.

Furthermore, when only the classes required for a specific service are learned, the output dimension of the detection head is reduced, and the number of parameters and a computational load are reduced, which results in improved learning stability and enhanced inference speed. This approach not only improves efficiency in a resource-constrained environment but also achieves the optimal performance suited to the service objectives.

Accordingly, the resource usage controller according to an embodiment of the present disclosure may optimize resource usage by differentially applying models of various sizes and selectively using only a small number of classes actually used in each service.

In the present disclosure, a lightweight model is applied to an edge device or a real-time service to ensure speed and memory efficiency, and a large-scale model may be selectively used when high precision is required. Also, when only the target objects of interest are learned, rather than all classes, the output dimension of the detection head is reduced, and the number of parameters and a computational load are reduced, whereby learning stability and inference speed are improved. This approach improves efficiency in resource-constrained environments and contributes to achieving performance that fits the service objectives.

More specifically, in the process of updating service environment information using an AI model generated based on service input according to an embodiment of the present disclosure, the inference result and policy update result for a service, which are obtained through the inference model of an AI inference model generation system, are updated in a YAML file by the resource usage controller, and are then utilized by an AI server and an AI robot, as illustrated in FIG. 8.

Service A and service B may provide objects and environmental information observed in actual services.

An AI execution environment analyzer may analyze an execution environment by receiving hardware constraints, a latency goal, network bandwidth, deployment types, and the like of each service as service input.

The AI execution environment analyzer may analyze service environment information acquired from the service input.

An optimized model configuration generator may perform adjustment according to the characteristics of the service based on the analyzed service environment information

The optimized model configuration generator may optimize classes, labels, input/output specifications, training parameters, and inference and deployment settings.

The optimized model configuration generator may adjust at least one of input resolution of the service, a backbone structure, the number of classes, anchor settings, or floating-point precision, or a combination thereof in the service environment information.

A training dataset generator may generate a training dataset for each service by combining the service environment information with object and labeling data of the service.

For service A, object classes and labeling data may be generated and provided as training input, and for service B, object classes and labeling data may be generated and provided as training input.

An AI model learning machine may perform training by receiving object classes and labeling data for each service.

A pre-made base AI inference model (reference as base AI model) is classified into types such as large, normal, and tiny, and may be a fixed AI model.

The AI model learning machine may generate an updatable AI inference model by training a predetermined suitable fixed AI model selected from among multiple fixed AI models based on the service environment information.

The updatable AI model may be variably updated according to a change in the actual service even after training is completed.

Each of an AI inference model reflecting service A and an AI inference model reflecting service B may be generated in a form that reflects the actual service environments and object characteristics thereof.

An optimized AI inference model selector may select an optimal model for each service by evaluating various metrics, such as accuracy, latency, memory usage, power consumption, and the like of candidate models.

For example, the optimized AI inference model selector may output a fixed AI model according to need, thereby supporting stable deployment.

A resource usage controller may collect inference data from an optimal model that is trained by the optimized AI inference model selector.

The resource usage controller updates a YAML file using the inference data such that a resource policy is automatically reflected when subsequent deployment or retraining is performed.

Also, the process of generating and applying an AI model according to an embodiment of the present disclosure may be further included in the resource allocation information and QoS information analysis step (S110) illustrated in FIG. 2.

The process of updating service environment information using an AI model generated based on service input according to an embodiment of the present disclosure may include inputting and analyzing a service at step S210, applying a service object class and labeling data at step S220, generating a model at step S230, and optimizing the model at step S240.

At step S210, the current environment of each service may be considered and analyzed, and training input may be provided.

At step S210, the priority of object classes and required performance may be estimated based on collected various environment variables.

At step S210, when an environmental change is detected, a revaluation trigger is generated to notify the subsequent step.

Also, at step S220, the object class and labeling data of each service may be applied.

At step S220, the object class for each service may be received from an object class generator.

At step S220, labeling data that passes quality verification may be received from a labeling data generator.

For example, at step S220, resampling or weighted loss may be applied to correct imbalance of class distribution.

Here, at step S220, the service environment information acquired from the service input may be adjusted depending on the characteristics of the service.

Here, at step S220, at least one of the input resolution of the service, a backbone structure, the number of classes, anchor settings, or floating-point precision, or a combination thereof may be adjusted in the service environment information.

At step S230, an AI inference model in which an actual service is reflected may be generated.

Also, at step S230, a pre-made AI inference model is selected as a base model, and transfer learning is performed, whereby an inference model that reflects the service may be generated.

At step S230, accuracy, latency, and throughput may be measured through offline verification and online A/B evaluation.

At step S230, a predetermined suitable fixed learning model selected from among multiple fixed learning models based on the service environment is trained, whereby an inference model may be generated.

At step S230, a model reflecting service A and a model reflecting service B may be produced.

Also, at step S240, the AI inference model may be continuously optimized.

At step S240, optimization may be performed based on latency, accuracy, and resource efficiency by using the updatable AI inference model as input.

At step S240, an AI inference model that satisfies the target metrics may be automatically selected through the optimized AI inference model selector.

At step S240, based on the result data produced by the AI inference model in response to the service input, the container resource allocation information and the QoS profile in the YAML file may be updated.

At step S240, the resource usage controller reflects the optimization result and resource policy inferred from the selected AI inference model in the YAML file such that they are automatically reflected when subsequent deployment is performed.

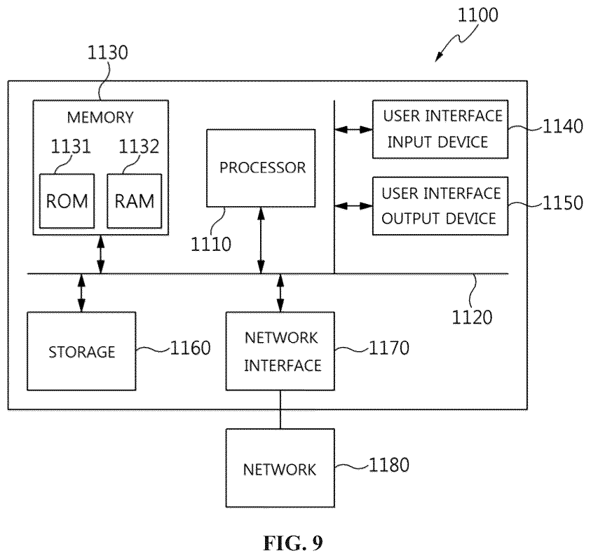

FIG. 9 is a view illustrating a computer system according to an embodiment of the present disclosure.

Referring to FIG. 9, the apparatus for resource usage optimization based on multi-layer distributed execution according to an embodiment of the present disclosure may be implemented in a computer system 1100 including a computer-readable recording medium. As illustrated in FIG. 9, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

Also, the apparatus for resource usage optimization based on multi-layer distributed execution according to an embodiment of the present disclosure includes one or more processors 1110 and memory 1130 for storing at least one program executed by the one or more processors 1110, and the at least one program parses and analyzes container resource allocation information and a QoS profile for multiple layers from predetermined deployment configuration data, executes an identical container image for each layer for which resource availability is confirmed based on the resource allocation information, determines whether QoS is satisfied by measuring a response period and computing performance for each executed layer based on the QoS profile, selects an optimal layer satisfying the resource availability and the QoS, and optimizes resource usage by gradually reducing resource usage setting parameters of the optimal layer, checking whether the QoS is satisfied at each reduction stage, and searching for a minimum resource value.

Here, the multiple layers are distinguished as work nodes in which at least one of a computing resource size, or a network processing speed, or a combination thereof differs.

Here, the at least one program may optimize the resource usage by dynamically adjusting the size or number of GPU instances according to a service load.

Here, the at least one program adjusts the size and number of instances based on GPU virtualization, which partitions a single GPU into multiple independent instances, thereby optimizing the resource usage.

Here, the at least one program may optimize resource usage by performing a predetermined inference service on a first instance and performing a predetermined training task on a second instance that is larger than the first instance.

Here, the QoS profile may include at least one of a deadline, reliability, durability, a latency budget, or a history item, or a combination thereof.

Here, the at least one program may generate and output optimal deployment configuration data that reflects the optimal layer and the minimum resource value.

Here, the at least one program may modify the resource usage setting parameters using the optimal deployment configuration data and search for the minimum resource value.

Here, the at least one program may generate an inference model by training a predetermined suitable fixed learning model selected from among multiple fixed learning models by adjusting service environment information acquired from predetermined service input according to the characteristics of a service.

Here, the at least one program may adjust at least one of input resolution of the service, a backbone structure, the number of classes, anchor settings, or floating-point precision, or a combination thereof in the service environment information.

Here, the at least one program may update the container resource allocation information and the QoS profile based on result data that the inference model produces for the predetermined service input.

The present disclosure may reduce wasted resources resulting from resource settings arbitrarily configured by a user by optimizing resource usage in an autonomous robot.

Also, the present disclosure may provide efficient usage of computing resources of an autonomous robot, improvement in real-time performance and response speed, efficiency in data processing and storage, improvement in energy efficiency, and scalability and flexibility.

As described above, the apparatus and method for resource usage optimization based on multi-layer distributed execution according to the present disclosure are not limitedly applied to the configurations and operations of the above-described embodiments, but all or some of the embodiments may be selectively combined and configured, so the embodiments may be modified in various ways.

What is claimed is:

1. An apparatus for resource usage optimization based on multi-layer distributed execution, comprising:
one or more processors; and
memory for storing at least one program executed by the one or more processors,
wherein the at least one program
parses and analyzes container resource allocation information and a Quality-of-Service (QoS) profile for multiple layers from predetermined deployment configuration data,
executes an identical container image for each layer for which resource availability is confirmed based on the resource allocation information,
determines whether QoS is satisfied by measuring a response period and computing performance for each executed layer based on the QoS profile,
selects an optimal layer satisfying the resource availability and the QoS, and
optimizes resource usage by gradually reducing resource usage setting parameters of the optimal layer, checking whether the QoS is satisfied at each reduction stage, and searching for a minimum resource value.

2. The apparatus of claim 1, wherein the multiple layers are distinguished as work nodes in which at least one of a computing resource size, or a network processing speed, or a combination thereof differs.

3. The apparatus of claim 1, wherein the at least one program optimizes the resource usage by dynamically adjusting a size or number of GPU instances according to a service load.

4. The apparatus of claim 3, wherein the at least one program optimizes the resource usage by adjusting the size and number of instances based on GPU virtualization that partitions a single GPU into multiple independent instances.

5. The apparatus of claim 1, wherein the at least one program optimizes the resource usage by performing a predetermined inference service on a first instance and performing a predetermined training task on a second instance that is larger than the first instance.

6. The apparatus of claim 1, wherein the QoS profile includes at least one of a deadline, reliability, durability, a latency budget, or a history item, or a combination thereof.

7. The apparatus of claim 1, wherein the at least one program generates and outputs optimal deployment configuration data that reflects the optimal layer and the minimum resource value.

8. The apparatus of claim 7, wherein the at least one program modifies the resource usage setting parameters using the optimal deployment configuration data and searches for the minimum resource value.

9. The apparatus of claim 7, wherein the at least one program generates an inference model by training a predetermined suitable fixed learning model selected from among multiple fixed learning models by adjusting service environment information acquired from predetermined service input according to characteristics of a service.

10. The apparatus of claim 9, wherein the at least one program adjusts at least one of input resolution of the service, a backbone structure, a number of classes, anchor settings, or floating-point precision, or a combination thereof in the service environment information.

11. A method for resource usage optimization based on multi-layer distributed execution, performed by an apparatus for resource usage optimization based on multi-layer distributed execution, comprising:
parsing and analyzing container resource allocation information and a Quality-of-Service (QoS) profile for multiple layers from predetermined deployment configuration data;
executing an identical container image for each layer for which resource availability is confirmed based on the resource allocation information;
determining whether QoS is satisfied by measuring a response period and computing performance for each executed layer based on the QoS profile;
selecting an optimal layer satisfying the resource availability and the QoS; and
optimizing resource usage by gradually reducing resource usage setting parameters of the optimal layer, checking whether the QoS is satisfied at each reduction stage, and searching for a minimum resource value.

12. The method of claim 11, wherein the multiple layers are distinguished as work nodes in which at least one of a computing resource size, or a network processing speed, or a combination thereof differs.

13. The method of claim 11, wherein optimizing the resource usage comprises optimizing the resource usage by dynamically adjusting a size or number of GPU instances according to a service load.

14. The method of claim 13, wherein optimizing the resource usage comprises optimizing the resource usage by adjusting the size and number of instances based on GPU virtualization that partitions a single GPU into multiple independent instances.

15. The method of claim 11, wherein optimizing the resource usage comprises optimizing the resource usage by performing a predetermined inference service on a first instance and performing a predetermined training task on a second instance that is larger than the first instance.

16. The method of claim 11, wherein the QoS profile includes at least one of a deadline, reliability, durability, a latency budget, or a history item, or a combination thereof.

17. The method of claim 11, wherein optimizing the resource usage comprises generating and outputting optimal deployment configuration data that reflects the optimal layer and the minimum resource value.

18. The method of claim 17, wherein optimizing the resource usage comprises modifying the resource usage setting parameters using the optimal deployment configuration data and searching for the minimum resource value.

19. The method of claim 11, wherein analyzing the container resource allocation information and the QoS profile comprises generating an inference model by training a predetermined suitable fixed learning model selected from among multiple fixed learning models based on a service environment by adjusting service environment information acquired from predetermined service input according to characteristics of a service.

20. The method of claim 19, wherein analyzing the container resource allocation information and the QoS profile comprises adjusting at least one of input resolution of the service, a backbone structure, a number of classes, anchor settings, or floating-point precision, or a combination thereof in the service environment information.
